(19) United States
(12) Patent Application Publication
(10) Pub. No.: US 2014/0218400 A1
(43) Pub. Date: Aug. 7, 2014

(54) Method for Providing Real Estate Data on an Interactive Map

(71) Applicant: PropertyRadar, Inc., Truckee, CA (US)

(72) Inventors: Sean O'Toole, Truckee, CA (US); Brian Panulla, Portland, OR (US); Rob Lusardi, Portland, OR (US); Justin Barry, Lake Oswego, OR (US); Gregory Haun, Truckee, CA (US)

(73) Assignee: PropertyRadar, Inc., Truckee, CA (US)

(21) Appl. No.: 14/173,258

(22) Filed: Feb. 5, 2014

Related U.S. Application Data
(60) Provisional application No. 61/760,859, filed on Feb. 5, 2013.

(51) Int. Cl. G06T 11/60

(52) U.S. Cl. CPC G06T 11/60
USPC 345/634

(57) ABSTRACT

A method for providing real estate data on an interactive map which provides an interactive map display over which various real estate data layers may be overlaid to provide information regarding displayed property parcels. The present invention generally includes a central communication unit and a user device communicatively interconnected with the central communication unit via a communications network. The central communication unit is adapted to periodically access real estate data from one or more data providers to maintain a data repository containing real estate data regarding a plurality of properties. The user device utilizes a software application to retrieve such real estate data from the central communication unit and display a user interface having a map showing a plurality of map tiles. A data layer may be overlaid over the map to provide the real estate data in an easy-to-read manner while exploring a geographic area on the map.

### CROSS REFERENCE TO RELATED APPLICATIONS

I hereby claim benefit under Title 35, United States Code, Section 119(e) of U.S. provisional patent application Ser. No. 61/760,859 filed Feb. 5, 2013. The 61/760,859 application is currently pending. The 61/760,859 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a mapping interface and more specifically it relates to a method for providing real estate data on an interactive map which provides a user interface allowing navigation of a map display over which may be overlaid various real estate data layers to provide information regarding displayed property parcels.

2. Description of the Related Art

Any discussion of the related art throughout the specification should in no way be considered as an admission that such related art is widely known or forms part of common general knowledge in the field.

Development of the Internet has considerably advanced the ease of accessing various real estate data to aid in real estate property searches. Previous methods of real estate searching such as utilizing newspaper classifieds or relying entirely on real estate professionals have been supplanted by the wide availability of various real estate searching platforms, such as web-based real estate searching and mapping applications like ZILLOW or TRULIA.

While the functionalities of such existing online tools are a step up from previous methods for real estate data retrieval, there are improvements which could still be realized in the field. The information retrievable from prior art searching tools is generally limited to only basic information regarding properties. Prior art tools also suffer from inefficient and oftentimes confusing user interfaces and map displays which can lead to unnecessary stress attempting to retrieve real estate data. Additionally, these prior art tools often omit substantially relevant information in a real estate search which can necessitate utilization of multiple tools by a user wishing to obtain a robust understanding of a specific property parcel or other relevant real estate data.

Because of the inherent problems with the related art, there is a need for a new and improved method for providing real estate data on an interactive map which provides a user interface allowing navigation of a map display over which may be overlaid various real estate data layers to provide information regarding displayed property parcels.

### BRIEF SUMMARY OF THE INVENTION

The invention generally relates to a method for providing a method for providing real estate data on an interactive map which includes a central communication unit and a user device communicatively interconnected with the central communication unit via a communications network. The central communication unit is adapted to periodically access real estate data from one or more data providers to maintain a data repository containing real estate data regarding a plurality of properties. The user device utilizes a software application to retrieve such real estate data from the central communication unit and display a user interface having a map showing a plurality of map tiles. A data layer is overlaid over the map to provide the real estate data in an easy-to-read manner while exploring a geographic area on the map.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of an exemplary computer system for use with the present invention.

FIG. 2 is a block diagram illustrating communications between the central communication unit, user device, and data providers of the present invention.

FIG. 3 is a block diagram illustrating communications between various modules of the present invention.

FIG. 4 is an illustration of an exemplary user interface of the present invention utilized to select data layers.

FIG. 5 is an illustration of an exemplary user interface at a first zoom setting with a first data layer applied.

FIG. 6 is an illustration of an exemplary user interface at a second zoom setting with the first data layer applied.

FIG. 7 is an illustration of an exemplary user interface having a second data layer applied.

FIG. 8 is an illustration of an exemplary user interface having a third data layer applied.

FIG. 9 is a flow chart illustrating periodic retrieval of real estate data by the central communication unit from one or more data providers.

FIG. 10 is a flow chart illustrating the creation and display of the user interface by the user device.

FIG. 11 is a flow chart illustrating updating the user interface in response to user inputs.

FIG. 12 is a flow chart illustrating communication between modules during application of data layers.

FIG. 13 is a flow chart illustrating usage of the present invention to view a larger area with data layer applied prior to zooming in to a point of interest on the map display.

FIG. 14 is a flow chart illustrating centering of the map display on the point of interest.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a communications network, such as the Internet.

### A. Overview of Invention.

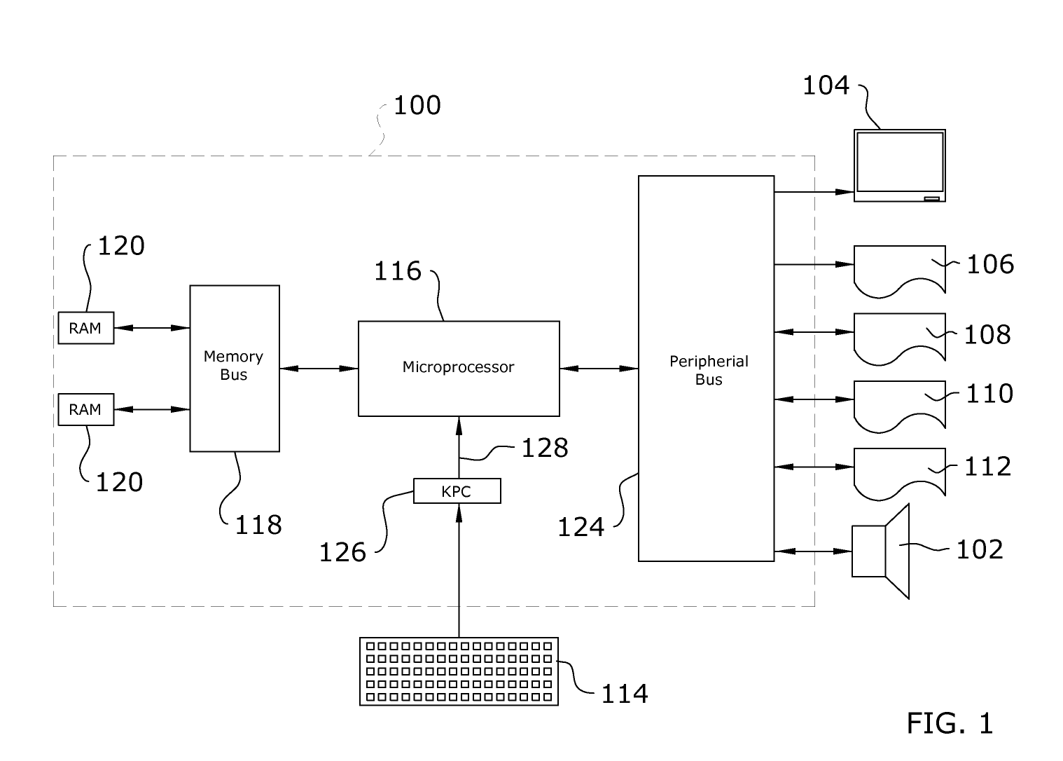

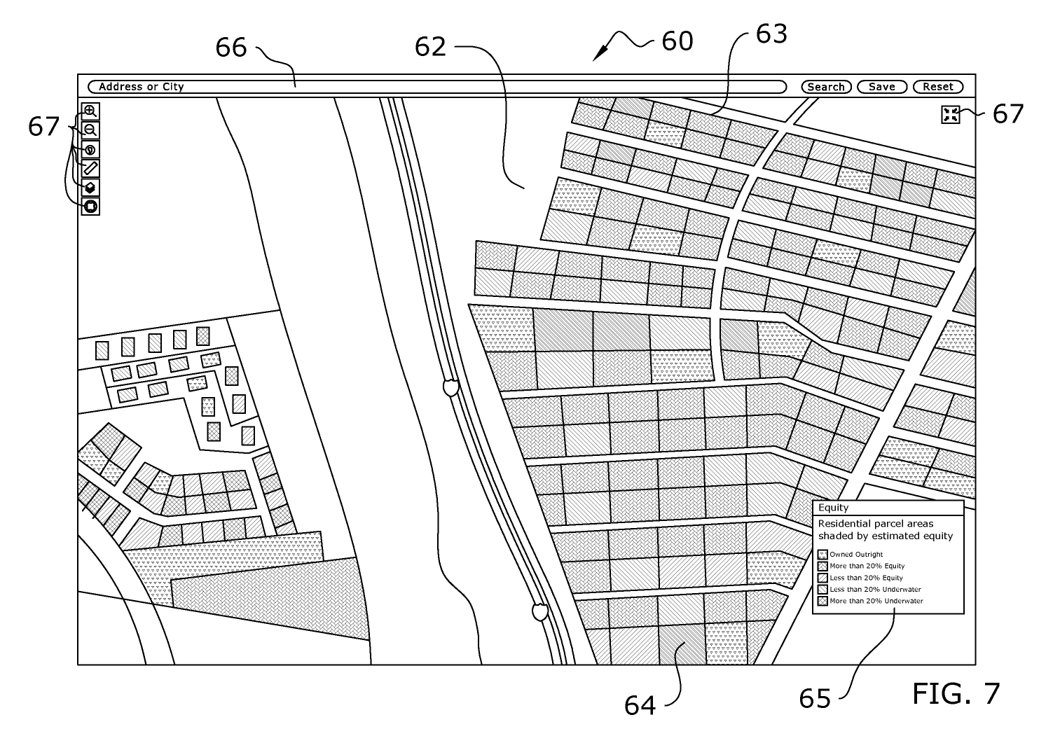

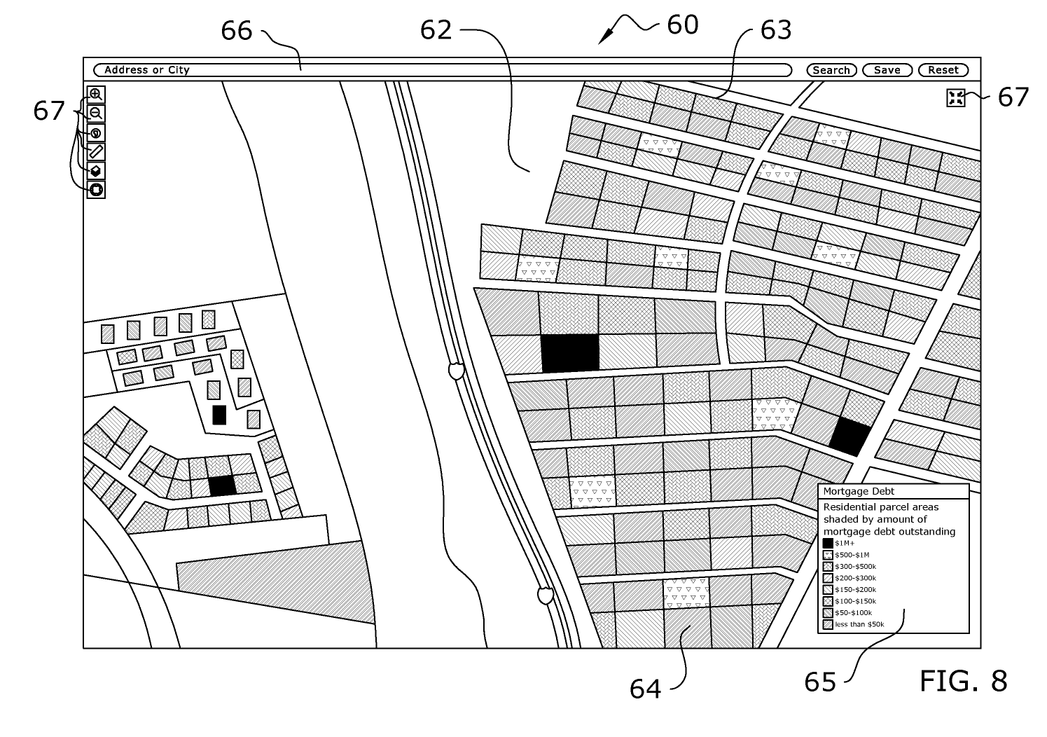

FIGS. 1-14 illustrate the present invention. The method for providing real estate data on an interactive map 10 generally includes a central communication unit 20 and a user device 30 communicatively interconnected with the central communication unit 20 via a communications network 12. The central communication unit 20 is adapted to periodically access real estate data from one or more data providers 40 to maintain a data repository 22 containing real estate data regarding a plurality of properties. The user device 30 utilizes a software application to retrieve such real estate data from the central communication unit 20 and display a user interface 60 having a map showing a plurality of map tiles 63. A data layer 64 may be overlaid over the map to provide the real estate data in an easy-to-read manner while exploring a geographic area on the map.

### B. Exemplary Computer System.

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. The computer system 100 also includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers. It can be appreciated that the computer system 100 may be comprised of various other electronic devices including but not limited to mobile phones, telephones, personal digital assistants (PDAs), handheld wireless devices, two-way radios, smart phones, communicators, video viewing units, television units, television receivers, cable television receivers, pagers, communication devices, and digital satellite receiver units.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 110. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The present invention may be embodied within various languages and technologies such as but not limited to JAVA, JAVASCRIPT, JSCRIPT, WMLSCRIPT, ACTIVEX, CGI, scripts, plug-ins, BASIC, VISUAL BASIC, C, C++, COBOL, FORTRAN, ADA, HTML, DHTML, XML, SGML, WML, HDML, FLASH, SHOCKWAVE, GIF, JPEG, ADOBE ACROBAT, PDF, MICROSOFT WORD, and PASCAL. The present invention may be operated upon various operating systems such as but not limited to UNIX, MACINTOSH, LINUX, WINDOWS, PALMOS, EPOC, ANDROID, IOS, WINDOWS CE, FLEXOS, OS/9, and JAVAOS.

### C. Exemplary Communications Network.

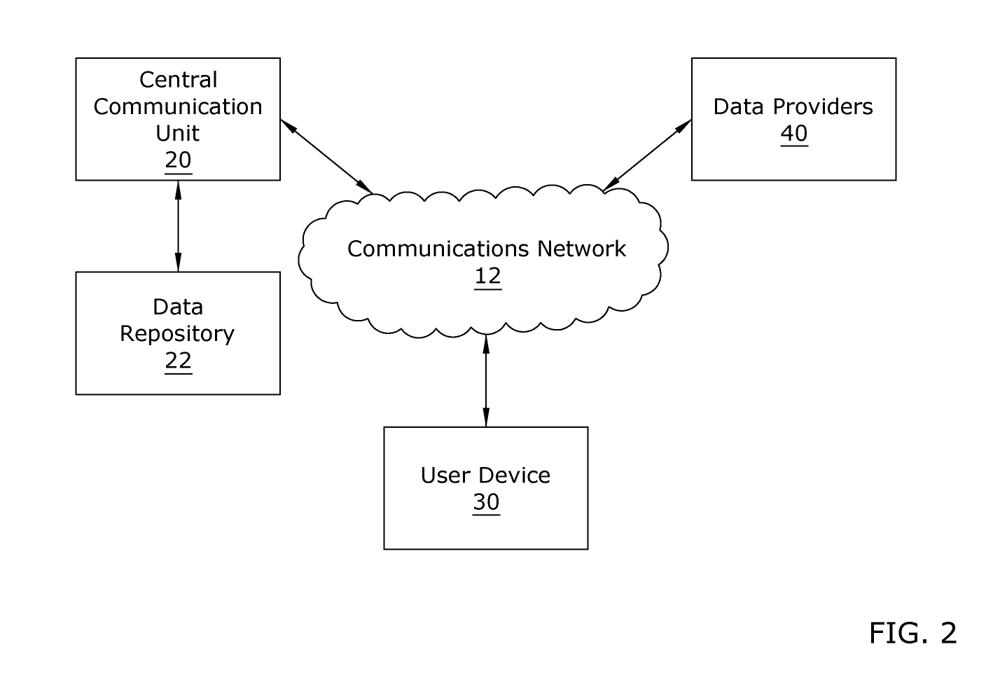

As shown in FIG. 2, the Internet 12 is an exemplary communications network 12 for the present invention. The Internet 12 is basically comprised of a “global computer network.” A plurality of computer systems 20, 30, 40 around the world are in communication with one another via this global computer network and are able to transmit various types of data between one another. The communications between the computer systems 20, 30, 40 may be accomplished via various methods such as but not limited to wireless, Ethernet, cable, direct connection, telephone lines, and satellite. One or more web servers typically provide data to the computer systems 20, 30, 40 connected via the Internet 12.

The present invention may also be utilized upon global computer networks, local area networks (LAN), wide area networks (WAN), campus area networks (CAN), metropolitan-area networks (MAN), and home area networks (HAN). Various protocols may be utilized by the electronic devices for communications such as but not limited to HTTP, SMTP, FTP and WAP (Wireless Application Protocol). The present invention may be implemented upon various wireless networks such as but not limited to CDPD, CDMA, GSM, PDC, PHS, TDMA, FLEX, REFLEX, IDEN, TETRA, DECT, DATATAC, and MOBITEX. The present invention may also be utilized with online services and internet service providers such as AMERICA ONLINE (AOL), COMPUSERVE, WEBTV, and MSN INTERNET SERVICES. The present invention preferably utilizes the Internet 12 for transmitting data, however it can be appreciated that as future technologies are created that various aspects of the invention may be practiced with these improved technologies.

### D. Central Communication Unit.

The central communication unit 20 may be comprised of any central communication device or system where communications are preferably established with by the user device 30 for performing the various functions of the present invention. While the singular term “unit” is used throughout the application, it should be appreciated that the central communication unit 20 may be comprised of a plurality of units which, together, perform the various functions set out herein.

The central communication unit 20 may be comprised of one or more server computers, cloud based computers, virtual computers, home computers or other computer systems capable of receiving and transmitting data via IP networks and the communications networks 12. The central communication unit 20 may be comprised of any electronic system capable of receiving and transmitting information (e.g. voice data, computer data, etc.).

The central communication unit 20 may host a website or application which is utilized in combination with the one or more user devices 30 to perform the various functionalities of the present invention. The central communication unit 20 is preferably communicatively interconnected with the user device(s) 30 and data providers 40 through the communications network 12. As can be appreciated, a modem or other communication device may be required between each of the central communication units 20, user devices 30, data providers 40 and the corresponding telecommunications networks 12.

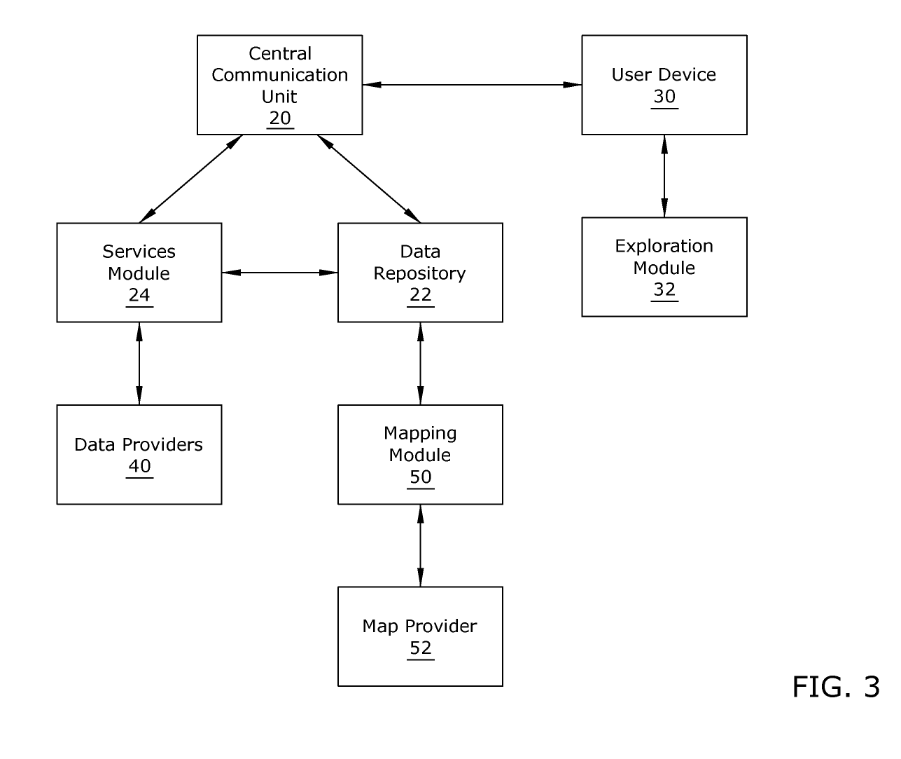

As best shown in FIGS. 2 and 3, the central communication unit 20 is preferably comprised of an off-location computing device (such as one or more server computers) which is adapted to transmit and receive data with the one or more user devices 30 and one or more data providers 40 of the present invention. The central communication unit 20 may be implemented across multiple devices or may be comprised of a single computing device. In embodiments implementing the central communication unit 20 across multiple devices, those devices may themselves be interconnected via a communications network 12.

As shown in FIG. 3, the central communication unit 20 includes a data repository 22 which stores various data retrieved from data providers 40. The data repository 22 generally comprises a database which is either stored upon or communicatively interconnected with the central communication unit 20. The data repository 22 may be stored entirely on a single device or may be implemented across multiple devices. The data repository 22 may be integral with the central communication unit 20 or may be stored on a completely different device (or devices) which are communicatively interconnected with the central communication unit 20, such as through a communications network 12.

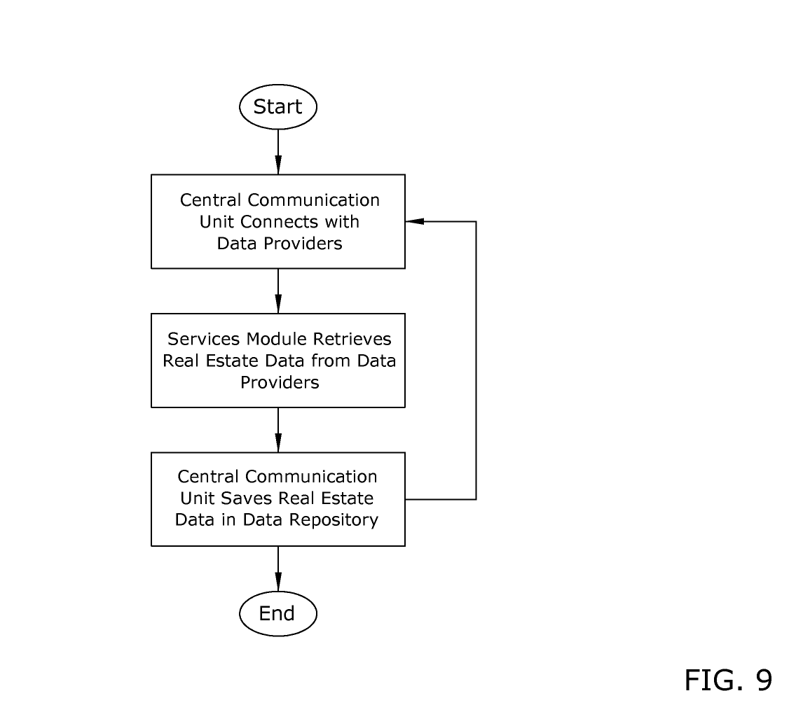

As illustrated in FIG. 9, the data may be retrieved automatically or manually from the data providers 40 through the communications network 12. In a preferred embodiment, the central communication unit 20 will be adapted to automatically and periodically update data in the data repository 22, such as through retrieving such data from a data provider 40.

Retrieved data may include parcel data on a parcel-by-parcel basis for all properties in the areas covered by the present invention. Such parcel data may include parcel boundaries, financial history, ownership information, foreclosure status, legal notices, and all other relevant data regarding a property parcel which is retrievable from a data provider 40 or through other means.

The central communication unit 20 may utilize the parcel data to calculate and correlate additional information regarding each parcel. Generation of such additional information uses a process which correlates quantitative and qualitative parcel data with multiple geospatial and descriptive datasets retrieved from data providers 40. This process is preferably multilayered, encompassing several optimized stages of simple value matching, fuzzy matching, and geospatial inference.

The result of such data correlation, comprised of correlated parcel data, is stored within the data repository after data correlation processes are complete. The correlated parcel data represents an integrated geospacial dataset which includes geolocation, land parcel and political boundary lines. It also may include descriptive data about the relevant property parcel. These functions of the present invention are described in more detail below.

As shown in FIG. 3, the central communication unit 20 generally implements a services module 24 which interacts with the user device 30 (such as through the software application or web browser). The services module 24 provides support required by the exploration module 32 of the user device 30 to implement the various features of the present invention. Such support may include searching functionalities handled server-side to aid in identifying specific locations or objects on which to focus the map display 62. The services module 24 may also aid in the lookup and delivery of information related to data layers 64, parcel data, or other real estate data upon request by the user device 30.

### E. User Device.

The user device 30 may be comprised of any type of computer for practicing the various aspects of the present invention. The user device 30 will preferably be adapted to communicate with the central communication unit 20 via the communications network 12 as shown in FIG. 2. The user device 30 may connect with the central communication unit 20 via a website (i.e. through a web browser) or via a software application (i.e. by downloading the application from a mobile application store, such as GOOGLE PLAY STORE or APPLE ITUNES).

By way of example, the user device 30 can be a personal computer (e.g. APPLE® based computer, an IBM based computer, or compatible thereof) or tablet computer (e.g. IPAD®). The user device 30 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The present invention may be implemented and viewed upon various types and brands of web/e-mail browsers run on a user device 30 such as but not limited to MICROSOFT INTERNET EXPLORER, NETSCAPE NAVIGATOR, MOZILLA FIREFOX, SAFARI, OPERA, AMAYA, ARENA, LYNX, HOTJAVA, MOZILLA, ICAB, MICROSOFT OUTLOOK, and MICROSOFT OUTLOOK EXPRESS. Browsers for handheld wireless devices, often times referred to as “microbrowsers”, are also capable of implementing the present invention. A browser is typically capable of displaying/playing various types of content including but not limited text, graphic, audio and multimedia.

The present invention may also be implemented and viewed through a software application similarly run on a user device 30. The software application may be implemented through various operating systems such as but not limited to MICROSOFT WINDOWS, LINUX, APPLE IOS, ANDROID, and the like. The software application may be distributed in physical form to be installed upon the user device 30 or may be distributed via the communications network 12.

As shown in FIG. 3, the software application or web browser of the user device 30 will generally implement an exploration module 32 which contains all of the client-side code to perform various functions of the present invention. Such functions may include interacting with the user, constructing and dispatching queries to the central communication unit 20, requesting map tiles 63 from a third-party map provider 52 (such as GOOGLE MAPS or BING MAPS).

The exploration module 32 may also be adapted to combine requested map tiles 63 into a complete map display 62 to form an interactive map. The module also manages navigation of the map display 62, including managing scroll and zoom functionality for the user device 30. The exploration module 32 also allows for the user to access detailed parcel data regarding each map tile 63. It should be appreciated that the shape, size, and configuration of the map tiles 63 may vary in different embodiments of the present invention. Thus, the exemplary configuration shown in the figures for the map tiles 63 should not be construed as limiting on the scope of the present invention.

In a preferred embodiment, the exploration module 32 forms part of the software application or web browser and provides the complete user interface 60 for navigating and examining the user interface 60 of the present invention, including examination of real estate data utilizing its map display 62. The exploration module 32 generally generates the user interface 60 utilizing information and data retrieved from the central communication unit 20, data providers 40, and/or map providers 52.

### F. Mapping Engine.

The present invention utilizes a mapping engine comprised of a mapping module 50 which may be stored and executed on the central communication unit 20 and/or the user device 30. FIG. 3 illustrates an embodiment in which the mapping module 50 is included as part of the central communication unit 20. As noted, the mapping module 50 may in other embodiments be implemented directly by the user device 30 or even a separate system to which the central communication unit 20 and/or user device 30 may connect via the communications network 12.

Depending on processing capabilities, the mapping engine may be implemented to create maps and map tiles 63 solely on the central communication unit 20 prior to delivery to the user device 30. In other embodiments, the mapping engine may be partially or wholly implemented on the user device 30 based on data received from the central communication unit 20.

The mapping engine, in response to requests from exploration module 32, creates map tiles 63 to form a map display 62 showing an interactive map on the user device 30 for a relevant area that reflects the current state of the properties being shown therein. The map tiles 63 are created by accessing parcel data stored within the data repository 22 and transforming the parcel data into graphic images.

The mapping engine may also be adapted to store and cache map tiles 63 for future use. The mapping engine will periodically manage the map tiles 63 to update information therein and expire old or obsolete map tiles 63 to ensure that current and up-to-date map tiles 63 are available upon request by the user device 30.

The mapping engine acts to provide the graphical tile generation required to deliver map tiles 63 required for display by the exploration module 32. Based on requests received from the user via the user device 30, the mapping engine will generate the map tiles 63 for display upon the user device 30. The mapping engine may also be adapted to return vector data for the exploration module 32 or other components of the present invention to display.

### G. Data and Map Providers.

As shown in FIGS. 2, 3, and 9, real estate data may be retrieved from one or more data providers 40 using the present invention. Real estate data may take a number of forms, including audio, visual, textual, and any combination thereof. Real estate data may include written or visual depictions of any subject matter relevant to the operations of the present invention which is accessible through the communications network 12, such as public tax information.

Data providers 40 are generally comprised of any provider of accessible information which is relevant to the operations of the present invention and accessible through the communications network 12, such as publicly-available information related to real estate. The data providers 40 and central communication unit 20 are communicatively interconnected via the communications network 12. The central communication unit 20, as described herein, will retrieve real estate data from one or more data providers 40 and then analyze, process, and collate the real estate data for delivery to the user device 30.

Third-party map providers 52 such as GOOGLE MAPS may also be utilized to provide the base layer map utilized by the mapping engine to formulate the final map for display. The data layers 64 and map tiles 63 are overlaid upon the base layer map by the central communication unit 20 and/or user device 30 of the present invention. The base layer map may comprise a street view, an aerial view, or a combination thereof. In some embodiments, third-party map providers 52 are not utilized and the base layer map may be stored and/or generated by the central communication unit 20 and/or user device 30.

### H. User Interface.

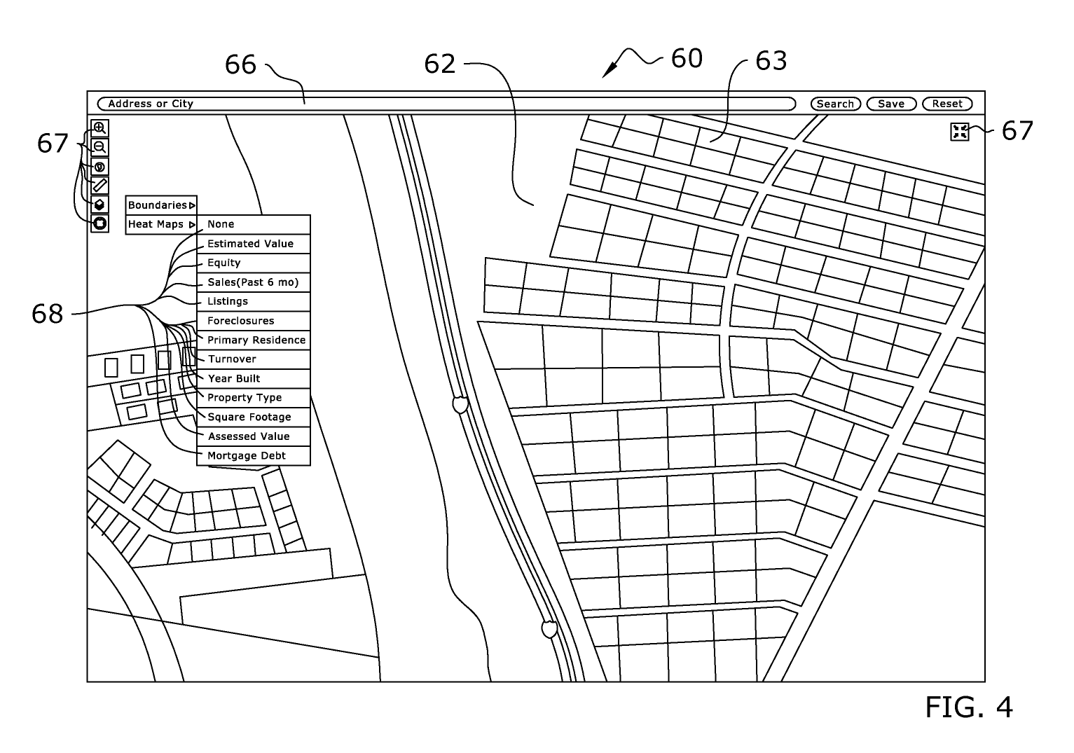

As illustrated in FIGS. 4-8, the present invention utilizes a user interface 60 which is displayed upon the user device 30. The appearance and configuration of the user interface 60 may vary in different embodiments of the present invention. The scope of the present invention should thus not be construed as being limited by the exemplary user interfaces 60 shown herein.

The user interface 60 is generated in a preferred embodiment by the exploration module 32 of the software application of the user device 30 from a combination of data and mapping information. In some embodiments, the user interface 60 may be generated by the central communication unit 20 and then delivered for display by the user device 30.

As shown in FIGS. 4-8, the user interface 60 will generally include a map display 62 which may be navigated utilizing the user device 30. Data layers 64 and other real estate data may be overlaid upon a base map layer which may be obtained from a third-party map provider 52. The user interface 60 may also include a legend 65 which pops up for each data layer 64 to identify any color-coding or symbols utilized within the specific data layer 64 overlaid on the map display 62 of the user interface 60.

The user interface 60 may include a number of elements, including a property search bar 66, map navigation tools 67, and data layer tools 68. The property search bar 66 may be utilized to locate a geographic area or location, such as a city, zip code, or specific address, on which to focus the map display 62. The map navigation tools 67 may be utilized to navigate the map display 62, such as zooming in and out, scrolling, or centering the map display 62 on a specific location. The data layer tools 68 may be utilized to select and manage different data layers 64 to be overlaid on the map display 62. Additional tools may be included, such as a tool which allows for measurement of objects, tiles, boundaries, distances, or other features displayed on the map display 62.

### I. Real Estate Data.

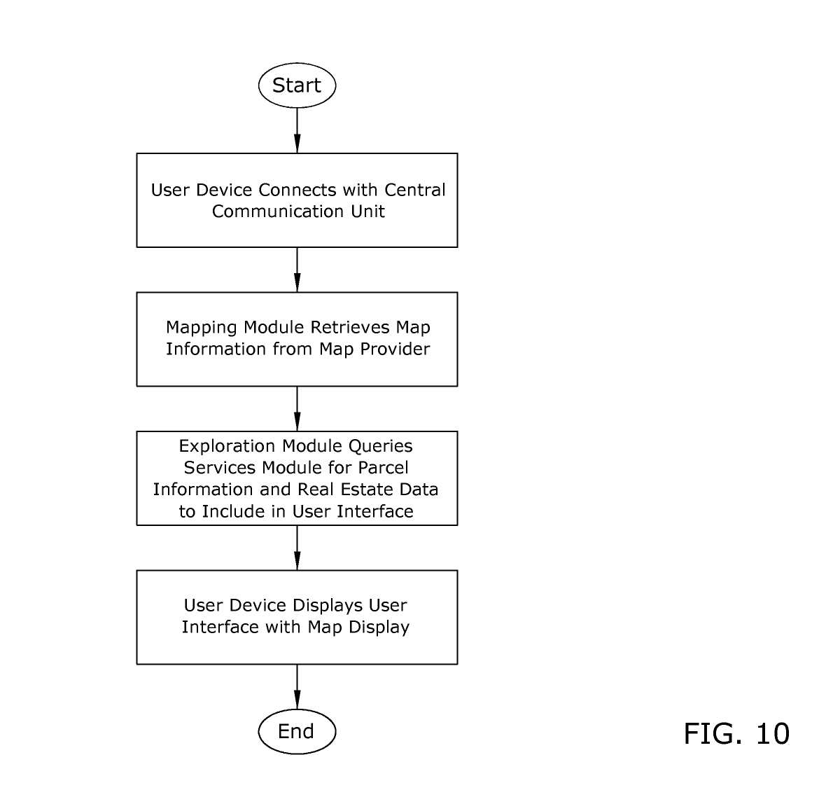

As shown in FIG. 10, the present invention may be utilized to retrieve, update, and display a wide range of real estate data for the map tiles 63 shown in the user interface 60. Exemplary descriptions follow for a subset of available real estate data which is retrievable or calculated by the present invention for use on the user interface 60. The scope of the present invention should not be construed as limited to the real estate data described herein, as any real estate data relevant to a real estate inquiry may also be included.

Real estate data may be grouped into specific ranges of values. These ranges may be utilized to color-code or symbol-code a data layer 64 to be overlaid upon the map display 62. For example, a first color may represent a first range of real estate data values and a second color may represent a second range of real estate data values. Map tiles 63 in the first range will be overlaid with the first color and map tiles 63 in the second range will be overlaid with the second color. A legend 65 may be included in the user interface 60 to identify the coding.

A first example of real estate data relevant for use with the present invention includes the estimated value for each property parcel, wherein each map tile 63 of the map display 62 contains and represents one or more property parcels. The estimated value overlaid using a data layer by the present invention is generally based upon an automated valuation model values which may be calculated by the central communication unit 20 using data retrieved from one or more data providers 40. The data layer 64 may be overlaid on the map display 62 to create a heat map or similar display which differentiates between properties with different ranges of estimated values.

Another example of real estate data relevant for use with the present invention includes sales data, such as the previous sales price for each property parcel shown in the map display 62. This data may be calculated utilizing various information retrieved from one or more data providers 40 by the central communication unit 20, such as various documents retrieved from public databases. The present invention is adapted to determine which sales represent arms-length, full-value market transactions utilizing an algorithm. The data layer 64 may be overlaid on the map display 62 to differentiate sales prices into ranges for the properties shown in the map display 62.

Real estate data may also include an asking price for each for-sale property shown in the map display 62. This information may be retrieved from data providers 40 such as a multiple listing service provider to provide an integrated view of the property marketplace. The data layer 64 may be overlaid on the map display 62 to create a display which identifies asking prices of each property by splitting the prices into ranges and providing color- or symbol-coding within the data layer 64.

Real estate data may also include foreclosure data for properties shown in the map display 62. Foreclosure data is obtained via public records from various data providers 40 and will aid in determining whether a property is subject to foreclosure proceedings. A data layer 64 may be overlaid upon the map display 62 to more easily identify any foreclosure data associated with a property.

Equity data, which determines an estimated amount of equity in a piece of property, may also be included in certain data layers 64 of the map display 62. Equity may be determined by the central communication unit 20 utilizing a combination of data retrieved from data providers 40 and the automated value model. For example, equity may be derived by comparing the total loan balance received from data providers 40 such as public records to the estimated value of the property derived from the automated value model. A data layer 64 may be overlaid upon the map display 62 to identify properties with different ranges of equity.

Debt data may be obtained by an algorithm run by the central communication unit 20 which utilizes information from the data providers 40. An estimated value of debt in each property is calculated by the central communication unit 20. A data layer 64 may be overlaid to more easily identify debt ranges for a number of properties shown in the map display 62.

Ownership data may also be included with the present invention. More specifically, the central communication unit 20 may determine whether a property is a primary residence or has another status. The central communication unit 20 will utilize information retrieved from data providers 40 to estimate the likelihood that a property is the owner's primary residence. This information may be included in a data layer 64 overlaid on the map display 62.

Other real estate data may be calculated, retrieved, and delivered by the central communication unit 20. For example, property type data may be determined from land use codes on public records retrievable from data providers 40. This data may be utilized to categorize properties into basic property type categories which may be identified in a data layer 64. Assessed value may also be included as real estate data, along with any other information/data which aids in analyzing a property (i.e. square footage, number of rooms, etc.).

### J. Operation of Preferred Embodiment.

In use, the central communication unit 20 will periodically retrieve real estate data from a number of data providers 40 as shown in FIG. 9. Information related to property parcels will be stored in the data repository 22 for retrieval and delivery to the user device 30 upon request by the software application or web browser.

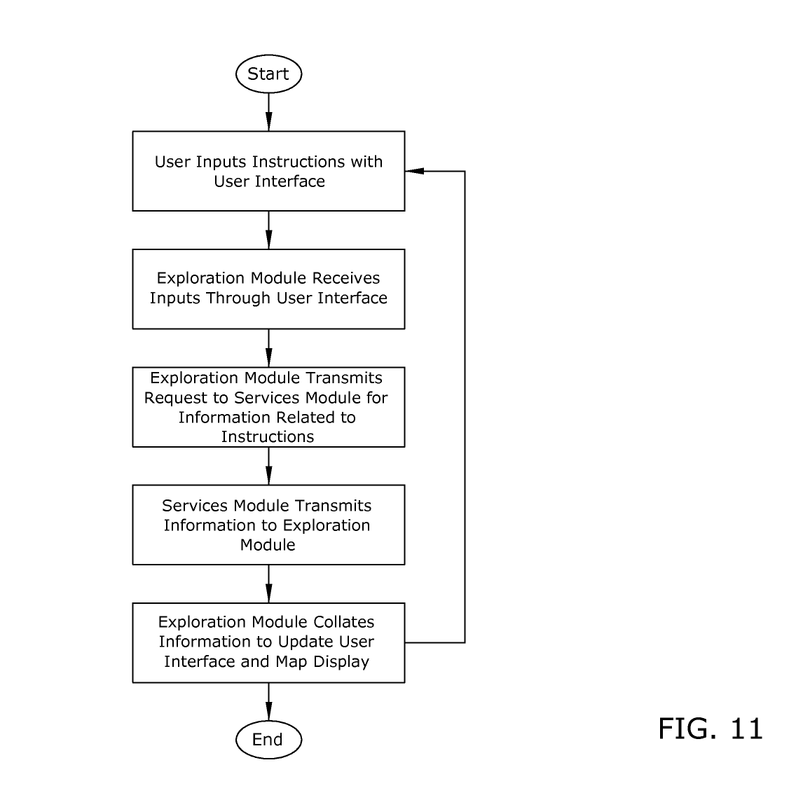

The creation and updating of the user interface 60 is best shown in FIG. 11. When a user first accesses the present invention, he will be presented with a user interface 60 which includes a map display 62. The exploration module 32 will send periodic queries to the services module 24 which will return relevant information and real estate data to be included in the user interface 60. The exploration module 32 may also send additional queries to the mapping engine and/or map providers 52 to receive any other information or data necessary for the display of map tiles 63 in the map display 62. The exploration module 32 will collate all information and data retrieved from the central communication unit 20 and/or map providers 52 to create the map display 62 which forms part of the user interface 60.

The user may navigate the map display 62 utilizing the navigation tools included in the user interface 60. For example, a property search bar 66 may be provided into which the user may enter various geographic identifiers to re-center the map display 62 on a specific address or location.

Zoom tools 67 may be included to magnify a given area and centering buttons may be included to center the map over a given location. A user may wish to set a first zoom level to have a general overview of an area. When a data layer 64 is positioned over this area, the user may be presented with a heat map or similar view which allows them to locate points of interest in the broader area shown in the map display 62. The user may then utilize the zoom tools 67 to focus the map display 62 on the points of interest to more closely view the properties in which they are interested based on the use of the data layers 64 in a zoomed out view.

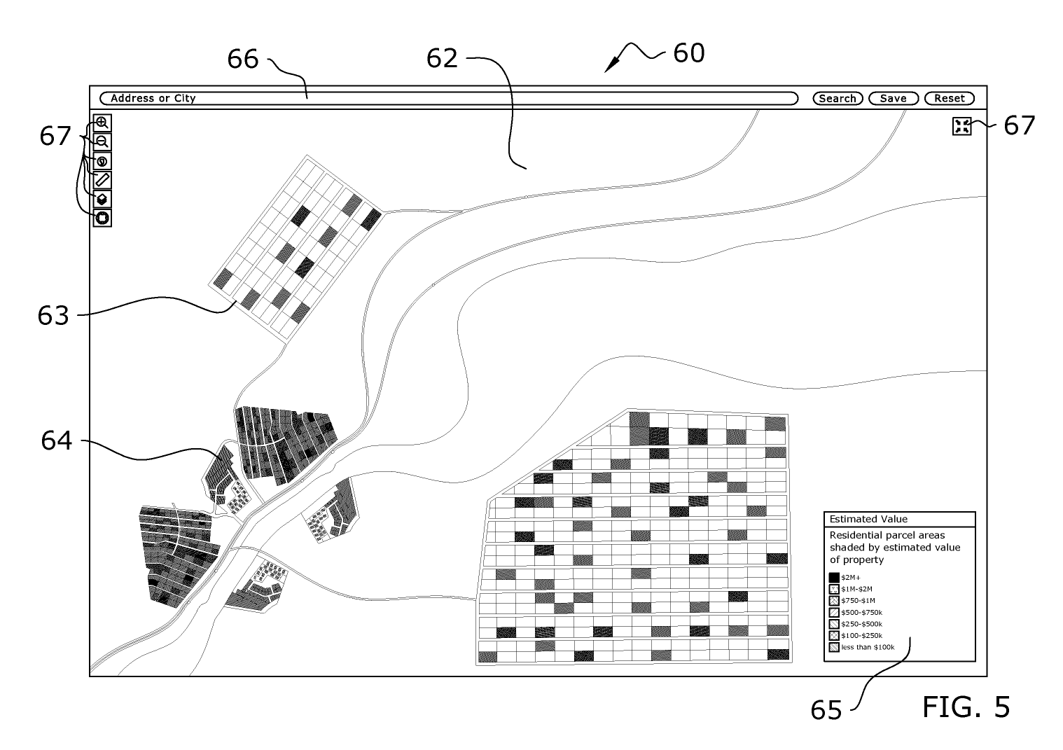

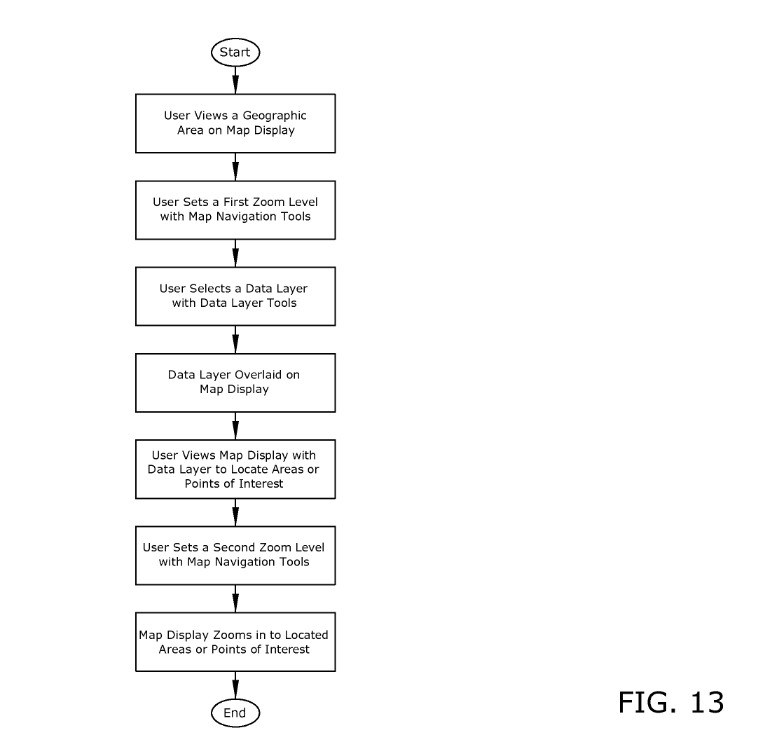

Using the above method, which is shown in FIG. 13, a real estate professional or other user may utilize the present invention to much more efficiently view a large geographical area for points of interest based on the real estate data most relevant to the user's inquiry. By first viewing a zoomed-out overview of the larger area as shown in FIG. 5, the data layer 64 may be examined for concentrations of properties most relevant to the user, such as properties with a certain foreclosure status.

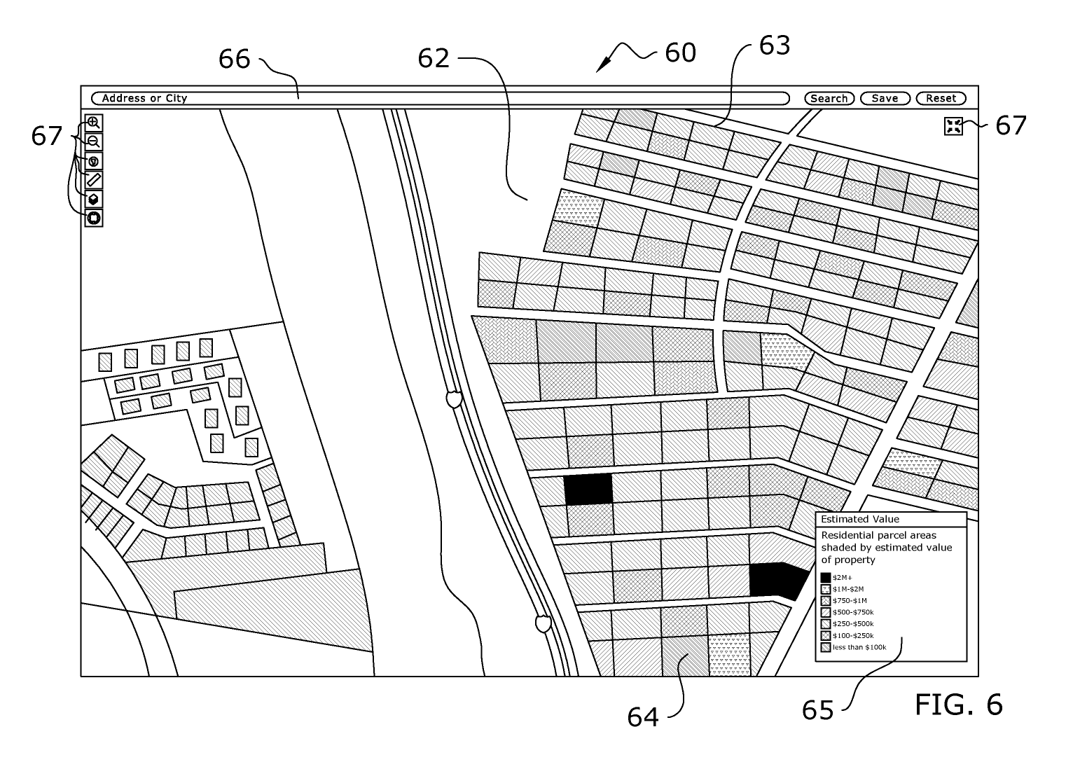

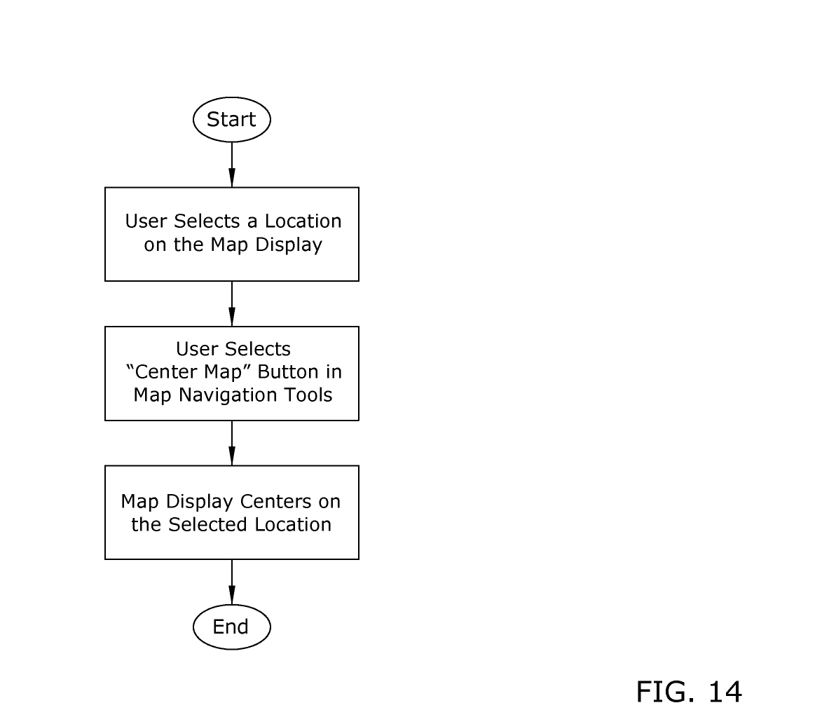

The user may then zoom in to that specific area to view the specific map tiles 63 as shown in FIG. 6 and pinpoint specific properties to inquire further into. Upon selecting one of the pinpointed properties, the user may utilize the map navigation tools 67 to center the map display 62 on that property using the method shown in FIG. 14.

Additional map navigation tools 67 such as a current location button may be used to center the map on the user's current location using GPS services. When the user moves, the map display 62 moves to keep the user's current location centered on the map display 62. In one embodiment, selecting a property takes the user to another screen with details about that property. Searching an address will center the map display 62 on the property at that address.

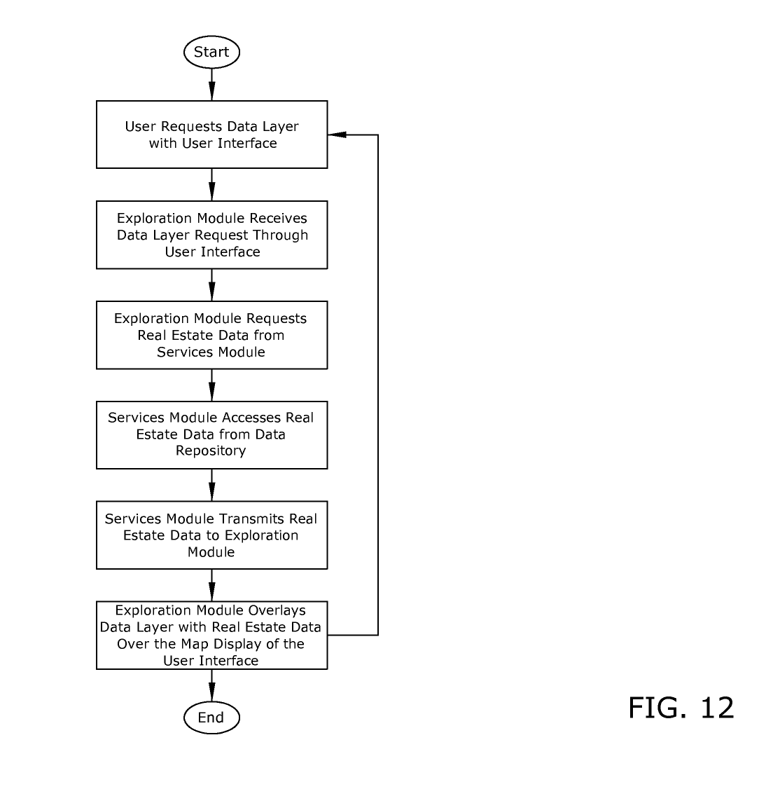

As the map display 62 is navigated by the user or different data layers 64 are selected, the exploration module 32 will repeatedly send services queries to the services module 24 of the central communication unit 20 and/or the map providers 52 to return information necessary for the exploration module 32 to update the map display 62. The exploration module 32 will assemble these images internally and display the resulting map or information on the user device 30 in the map display 62 of the user interface 60. This process is illustrated in FIG. 12.

The user interface 60 may include a tile selector which defines what each map tile 63 of the map display 62 represents. For example, the tile selector may be utilized to ensure that each map tile 63 corresponds with a property parcel. In another example, the tile selector may ensure that each map tile 63 corresponds with county boundaries or the like.

As best shown in FIG. 4, the user interface includes a data layer selector which may be comprised of a menu (such as a drop-down menu), a plurality of tabs, a plurality of buttons, or any other feature which allows for data layers 64 to be selected to be overlaid on the map display 62 or otherwise managed. The data layer selector includes a listing of available data layers 64 to be overlaid. Each data layer 64 corresponds with one or more of the real estate data retrieved and/or calculated by the central communication unit.

Upon overlay of a new data layer 64, a legend 65 may be provided on the user interface 60 to identify any colors, symbols, or other identifiers utilized to differentiate the real estate data values associated with each map tile 63 such as shown in FIG. 5. This legend 65 may be hidden upon request by the user. Selecting a map tile 63 on the map display 62 may cause additional real estate data to be displayed in a separate area of the user interface 60. By utilizing the legend 65 and data overlays for the map display 62, a user may efficiently access a wide range of real estate data within an easy-to-navigate, interactive map display 62.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A method for providing real estate data on an interactive map, comprising:
providing a central communication unit;
establishing communications with said central communication unit by a user device;
displaying an interactive map on said user device, wherein said interactive map includes a plurality of tiles representing a plurality of property parcels; and
overlaying a data layer on said interactive map, wherein said data layer corresponds to real estate data.

2. The method for providing real estate data on an interactive map of claim 1, wherein said data layer comprises a plurality of color codes relating to said real estate data.

3. The method for providing real estate data on an interactive map of claim 1, wherein said real estate data comprises a foreclosure status for said plurality of property parcels.

4. The method for providing real estate data on an interactive map of claim 3, wherein said data layer includes a first color to represent a first foreclosure status in said plurality of property parcels and a second color to represent a second foreclosure status in said plurality of property parcels.

5. The method for providing real estate data on an interactive map of claim 1, wherein said real estate data comprises an estimated amount of outstanding mortgage debt for said plurality of property parcels.

6. The method for providing real estate data on an interactive map of claim 5, wherein said data layer includes a first color to represent a first range of estimated mortgage debt in said plurality of property parcels and a second color to represent a second range of estimated mortgage debt in said plurality of property parcels.

7. The method for providing real estate data on an interactive map of claim 1, wherein said real estate data is selected from the group consisting of an estimated value for said plurality of property parcels, foreclosure status of said plurality of property parcels, type of property for said plurality of property parcels, assessed value of said plurality of property parcels, square footage for said plurality of property parcels, list price of said plurality of parcels, and past sales price of said plurality of property parcels.

8. The method for providing real estate data on an interactive map of claim 7, wherein said wherein said data layer comprises a plurality of color codes relating to said real estate data.

9. The method for providing real estate data on an interactive map of claim 8, further comprising the step of providing a menu to select said real estate data.

10. A method for providing real estate data on an interactive map, comprising:
connecting a central communication unit with a communications network;
establishing a connection between a user device and said central communication unit via said communications network;
storing real estate data for a plurality of property parcels within a database, wherein said central communication unit is in communication with said database;
displaying an interactive map on said user device, wherein said interactive map includes a plurality of tiles representing said plurality of property parcels; and
overlaying a data layer on said interactive map, wherein said data layer corresponds to said real estate data.

11. The method for providing real estate data on an interactive map of claim 10, wherein said data layer comprises a plurality of color codes relating to said real estate data.

12. The method for providing real estate data on an interactive map of claim 10, wherein said real estate data comprises an estimated equity value for said plurality of property parcels.

13. The method for providing real estate data on an interactive map of claim 12, wherein said data layer includes a first color to represent a first range of equity in said plurality of property parcels and a second color to represent a second range of equity in said plurality of property parcels.

14. The method for providing real estate data on an interactive map of claim 10, wherein said real estate data comprises an estimated amount of outstanding mortgage debt for said plurality of property parcels.

15. The method for providing real estate data on an interactive map of claim 14, wherein said data layer includes a first color to represent a first range of estimated mortgage debt in said plurality of property parcels and a second color to represent a second range of estimated mortgage debt in said plurality of property parcels.

16. The method for providing real estate data on an interactive map of claim 10, wherein said real estate data is selected from the group consisting of an estimated value for said plurality of property parcels, foreclosure status of said plurality of property parcels, type of property for said plurality of property parcels, assessed value of said plurality of property parcels, square footage for said plurality of property parcels, list price of said plurality of parcels, and/or past sales price of said plurality of property parcels.

17. The method for providing real estate data on an interactive map of claim 16, wherein said wherein said data layer comprises a plurality of color codes relating to said real estate data.

18. The method for providing real estate data on an interactive map of claim 17, further comprising the step of providing a menu to select a type of said real estate data.

19. The method for providing real estate data on an interactive map of claim 17, further comprising the step of periodically updating said real estate data by said central communication unit.

20. A non-transitory program storage device readable by a computer, embodying a program of instructions executable by the computer to perform method steps for providing real estate data on an interactive map, said method steps comprising:
providing a central communication unit;
connecting said central communication unit with a communications network;
providing a user device;
establishing a connection with said central communication unit by said user device via said communications network;
storing real estate data for a plurality of property parcels within a database of said central communication unit, wherein said real estate data includes an estimated amount of outstanding mortgage debt for said plurality of property parcels, an estimated equity value for said plurality of property parcels, an estimated value for said plurality of property parcels, foreclosure status of said plurality of property parcels, type of property for said plurality of property parcels, assessed value of said plurality of property parcels, square footage for said plurality of property parcels, list price of said plurality of parcels, and past sales price of said plurality of property parcels;
periodically updating said real estate data by said central communication unit;
displaying an interactive map on said user device, wherein said interactive map includes a plurality of tiles representing said plurality of property parcels;
overlaying a data layer on said interactive map, wherein said data layer includes a plurality of color-codes each representing one or more of said real estate data;
viewing a geographic area on said user device to pinpoint an area of interest based on said data layer; and
zooming in said interactive map to focus said interactive map on said area of interest in said geographic area.
